(19) United States
(12) Patent Application Publication
(10) Pub. No.: US 2008/0214716 A1
(43) Pub. Date: Sep. 4, 2008

(54) Use of a Thermally Curable Aqueous Composition as a Binder for Substrates

(76) Inventors: Axel Weiss, Speyer (DE); Manfred Weber, Mannheim (DE); Peter Claassen, Zevenaar (NL); Bernd Reck, Grunstadt (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/997,618

(22) PCT Filed: Jul. 28, 2006
(86) PCT No.: PCT/EP2006/064766

§ 371 Date: Feb. 1, 2008

(30) Foreign Application Priority Data
Aug. 3, 2005 (DE) 10 2005 037 113.2

(51) Int. Cl. C08K 3/26; C08K 3/22; B05D 5/02

(52) U.S. Cl. 524/424; 524/430; 427/427.4

(57) ABSTRACT

The present invention relates to the use of a heat-curable aqueous composition comprising dispersed polymer particles of at least
a) one polymer A1 comprising,
   98-100% by weight of ethylenically unsaturated monomers A, it being possible for up to 20% by weight of the monomers A to comprise glycidyl and/or hydroxyl groups and/or amino/amido groups, and the polymer comprising, incorporated in the form of polymerized units, ≦5% by weight of an α,β-ethylenically unsaturated mono- or dicarboxylic acid and at least 1% by weight of acrylonitrile, and 0-5% by weight of a bi- or polyfunctional monomer and
b) a polymer A2 which is soluble in the serum and comprises, incorporated in the form of polymerized units, 60-100% by weight of at least one α,β-ethylenically unsaturated mono- or dicarboxylic acid whose carboxyl groups can form an anhydride group, salts or mixtures thereof
c) and a polyfunctional crosslinking agent or mixtures thereof
d) and, if appropriate, divalent or trivalent metal ions which are added in the form of hydroxides, oxides, carbonates or bicarbonates
   as a binder for substrates.

The present invention relates to the use of formaldehyde-free heat-curable aqueous compositions as binders for substrates, in particular as binders for the production of bonded fiber webs. The invention furthermore relates to a process for the preparation of the binders.

Strengthening of fiber webs can be effected mechanically by calendering or needle-punching. In order to acheive a sufficient heat distortion resistance, however, mechanical strenghtening is not sufficient. A substantial improvement in the heat distortion resistance is achieved by strengthening by means of chemical binders which are applied to the fiber web in a conventional manner, for example in the form of aqueous polymer dispersions.

In order to increase the strength, in particular the wet strength and heat distortion resistance, binders which comprise formaldehyde-eliminating components are frequently used. Consequently, the problem of formaldehyde emissions during application and end use arises. Such aqueous polymer dispersions used as binders usually comprise a large amount of N-methylol groups, in order to ensure good heat distortion resistance of the polymer film and hence also of the bonded fiber web. N-methylol groups form covalent crosslinking bridges to hydroxyl or amido groups of the binder or the fibers of the sheet-like textile structure.

In order to achieve greater crosslinking, polymers soluble in the aqueous phase, such as water-soluble aminoplast resins, are added to such binders in some cases. Thus, U.S. Pat. No. 4,125,663 describes a polymer dispersion of this type, with which N-methylol groups in the form of urea or melamine-formaldehyde resins of the dispersion are mixed. Compounds such as, for example, N-methylolacrylamide or N-methylolmethacrylamide can also be incorporated directly into the dispersion in the form of polymerized units (U.S. Pat. No. 3,137,589).

For example, acrylonitrile, methyl methacrylate, acrylic acid, methacrylic acid, maleic acid, acrylamide or styrene and monomers which, in contrast to the abovementioned ones, have a low glass transition temperature in the polymer film are used as further monomers. Further monomers of this type having a relatively low glass transition temperature are, for example, butadine, isoprene or chloroprene. N-methylol group—containing dispersion polymers having such a composition usually have glass transition temperatures of at least 10° C., but in general are from 20° C. to 40° C.

Binders whose glass transition temperatures are in this range have the disadvantage that they impart considerable rigidity and hardness to the bonded fiber webs, which may lead to difficulties during processing at low temperatures.

For the production of the bonded fiber webs, drying is effected at temperatures of 130° C., but frequently at above 150° C., after application of the N-methylol group—containing dispersion, film formation and crosslinking of the polymer particles taking place. A disadvantage of the N-methylol group-containing binders is, as mentioned above, that considerable amounts of formaldehyde are liberated during the drying and are removed with the drying air. The N-methylol groups impart to the film and hence also to the fiber web good heat distortion resistance, which is lost if binders free of N-methylol groups are used.

Numerous alternatives to the binder systems known to date have already been proposed for avoiding formaldehyde emissions:

Thus, for example, N-methylolacrylamide or N-methylomethacrylamide can be replaced by crosslinking agents which do not eliminate formaldehyde, such as, for example, acrylamidoglycolic acid (EP 19169, EP 326298), N-(butoxymethyl)acrylamide (WO 92/08835).

A further formaldehyde-free alternative is the metal salt crosslinking of polymers.

Thus, DE 4004915 and DE 196 19 639 describe binders based on metal salt crosslinking inter alia for nonwovens. Since these are ionomers the water resistance is often unsatisfactory and the crosslinking density is temperature-dependent. Consequently, these must, if appropriate, be mixed with aminoplast or resorcinol resins in order to achieve the desired heat distortion and water resistances.

U.S. Pat. No. 3,404,116 and GB 1239902 each describe dispersion polymers based on copolymerizable monomers which comprise hydroxyl groups and are suitable as binders for paper, cellulose webs and similar fiber webs. Only good softness, flexibility and moisture resistance are said to be acheived. The problem of high heat distortion resistance is not discussed.

EP 345 566 describes binders dispersed in water for nonwovens, which comprise hydroxyalkylated copolymers and are thermally crosslinked with water-soluble formaldehyde-free imidazolidone derivatives.

US 20020187270 describes heat-curable binders based on an emulsion polymer which comprises carboxyl and acetoacetoxy groups and is crosslinked by mixing with polyaldehyde and polyaziridine derivatives.

EP 392 353 describes heat-curable binders for nonwovens comprising fiber webs based on emulsion polymers which comprise no further groups which are polymerizable or condensable with one another, and a water-soluble polymer which is composed substantially of N-hydroxycarboxymethylamides of acrylic and/or methacrylic acid.

U.S. Pat. No. 4,076,917 discloses binders which comprise carboxylic acid- or carboxylic anhydride-containing polymers and β-hydroxyalkylamides as crosslinking agents. The relatively complicated preparation of the β-hydroxyalkylamides is disadvantageous.

Heat-curable binders comprising polycarboxylic acids and polyols or alkanolamines are disclosed, for example, in EP 445 578, EP 583 086, EP 651 088, EP 672 920, EP 882 074, EP 882 003 or DE 199 49 592.

U.S. Pat. No. 5,314,943 describes a low-viscosity fast-curing binder for textile substrates, which is a mixture of an aqueous emulsion copolymer latex with an aqueous solution copolymer. The aqueous solution copolymer is obtained by copolymerization of an α,β-ethylenically unsaturated monocarboxylic acid and an α,β-ethylenically unsaturated dicarboxylic acid. The emulsion copolymer latex comprises units of monomers which are selected from alkenylaromatics, conjugated diolefins, vinyl acetate and acrylates.

U.S. Pat. No. 4,868,016 describes a composition based on at least one thermoplastic latex polymer insoluble in an aqueous alkaline medium and at least one alkali-soluble polymer which is incompatible with the latex polymer. The latex polymer is a polymer which is dispersed in water and may be composed of acrylic or methacrylic esters, vinylaromatic compounds and vinyl esters and additionally comprises from 0.5 to 3% by weight of an ethylenically unsaturated carboxylic acid incorporated in the form of polymerized units. The alkali-soluble polymer too is composed of said monomers but comprises from 10 to 60% by weight of an ethylenically unsaturated carboxylic acid. For adjusting the pH to >7, the composition may comprise amonia, triethylamine, ethylamine or dimethylhydroxyethylamine. It can be used for providing substrates with a coating.

EP 537 910 discloses mixtures of emulsion polymers which are preferably composed of styrene and n-butyl acrylate with acid-rich water-soluble polymers, which, when used as binders for paint coats, are said to lead to coatings having good substrate wetting and high solvent resistance.

EP 1 018 523 describes polymer dispersions which, in addition to the dispersed polymer particles in the serum, comprise water-soluble polycarboxylic acids and an alkoxylated long-chain amine and polyfunctional alcohols, which can be used as heat-curable binders for sheet-like structures and moldings.

DE 10151569 describes heat-curable binders based on an emulsion polymer, an acid polymer and an epoxide compound as a curing agent. In addition, an alkanolamine can be used as a curing agent in addition to the epoxide.

WO 99/09100 describes aqueous compositions which comprise an acid-rich polymer component, an acid-poor polymer component and an alkanolamine having at least two hydroxyl groups and can be used as heat-curable binders for moldings.

U.S. Pat. No. 4,670,505 describes a polyacrylate dispersion which is prepared by emulsion polymerization in the presence of from 0.05 to 5% by weight of a protective colloid, e.g. polyacrylic acid or its alkali metal salts, and from 0.1 to 5% by weight of a water-soluble aminoalcohol having 2 to 36 carbon atoms. The dispersion obtained has a low viscosity and a good pigment binding power and is substantially free of gel and stable to shearing. In the case of relatively large amounts of polyacrylic acid, the composition is said to exhibit a very high viscosity, which prevents use as a binder, for example for fibrous substrates.

EP 1 240 205 describes a heat-curable binder based on an emulsion polymer, which is prepared in the presence of a carboxyl-containing polymer.

In many applications of bonded fiber webs, in particular, based on polyester fibers, carbon fibers or glass surfacing mats, very good heat distortion resistance and room temperature strength of the bonded fiber web in combination with low water absorptivity is required. This property could be achieved to date only by bonded fiber webs comprising N-methylol-containing binders. In the case of the formaldehyde-free binders described to date in the prior art, insufficient strengths and/or excessivley high water absorptivities are observed in the case of good heat distortion resistances. In addition, colloidal stability problems or phase separation are observed in the case of mixtures of a plurality of components, in particular colloid-polymer mixtures. This subject is amply discussed in textbooks on colloid chemistry/physics, such as, for example, Evans and Wennerstrom “The Colloidal Domain” VCH, 1994.

In relation to the heat-curable binders known to date, it was the object of the present invention to provide a non-formaldehyde-emitting, heat-curable binder for substrates, such as mats or sheets, in particular for the production of bonded fiber webs.

The object was achieved, according to the invention, by the use of a heat-curable aqueous composition comprising dispersed polymer particles of at least
a) one polymer A1 comprising,
   98-100% by weight of ethylenically unsaturated monomers A, it being possible for up to 20% by weight of the monomers A to comprise glycidyl and/or hydroxyl groups and/or amino/amido groups, and the polymer comprising, incorporated in the form of polymerized units, ≦5% by weight of an α,β-ethylenically unsaturated mono- or dicarboxylic acid and at least 1% by weight of acrylonitrile, and 0-5% by weight of a bi- or polyfunctional monomer and
b) a polymer A2 which is soluble in the serum and comprises, incorporated in the form of polymerized units, 60-100% by weight of at least one α,β-ethylenically unsaturated mono- or dicarboxylic acid whose carboxyl groups can form an anhydride group, salts or mixtures thereof
c) and a polyfunctional crosslinking agent or mixtures thereof
d) and, if appropriate, divalent or trivalent metal ions which are added in the form of hydroxides, oxides, carbonates or bicarbonates
   as a binder for substrates.

The aqueous composition is prepared by free radical emulsion polymerization of polymer A1 in the presence of a polymer A2 and/or mixing of the polymer A2 with the emulsion polymer A1, and, if appropriate, subsequent addition of divalent or trivalent metal ions in the form of hydroxides, oxides, carbonates or bicarbonates and/or fillers.

The binders according to the invention are used, for example, as nonwovens for cleaning and wiping cloths and filter materials, as wallpaper substrate webs, in bituminized roofing sheets or binders for natural fibers or as inliners or substrate material for floor coverings, such as, for example, comprising PVC.

They are suitable, inter alia, for improving the strength of the moldings obtained therefrom, in particular the heat distortion resistance and water resistance, with high strengths in comparison with the binder systems used to date. The binder according to the invention preferably has high colloid stability and/or a low viscosity in combination with a high solids content. The binder should as far as possible be capable of being infinitely dilluted with water or dillute salt or surfactant solutions.

It is to be assumed that the system is present in a colloidal two-phase or multi-phase system after synthesis and also after dillution to liquid concentration (depletion separation). Regardless of the number of colloidal phases, the system should have the required performance characteristics after impregnation and drying.

The domain size of the phases may be in the μm to mm range with shearing, i.e. the phases can be “homogenized” again, by stirring if they should separate macroscopically.

Accordingly, the bonded fiber webs described at the outset were found. The invention furthermore relates to a method for their production and their use as cleaning or wiping cloths, as wallpaper substrate webs, for roofing sheets, as filter material or natural fiber moldings, and a production process for cleaning and wiping cloths, for wallpaper substrate webs, for roofing sheets, for filter materials and for natural fiber moldings.

The binders according to the invention generally have a content of from 10 to 70% by weight, preferably from 25 to 55% by weight, particularly preferably from 40 to 55% by weight, of nonvolatile constituents (solids content). The viscosity of the binders according to the invention at a solids content of about 50% by weight is in the range from 10 to 2000 mPas, preferably from 30 to 1000 mpas, measured using a rotational viscometer according to DIN 53019 at 23° C. and a shear rate of 250 s⁻¹.

The colloidal system (dispersed particles/water-soluble polymer/dispersing medium water) may be present both in homogenous (single-phase) form and in multi-phase form (depletion separation) after preparation and/or use (impregnation) or in the solids content range from 0.1 to 70% by weight. The polymers soluble in the serum may be partly or completely grafted on to the dispersed particles by chemical bonding and/or physical adsorption.

The weight ratio based on solids of the dispersed particles to dissolved serum constituent is in the range of 9:1 to 1:9, preferably from 4:6 to 6:4, and particularly preferably 1:1. The weight ratio of dissolved and grafted polymer to polyfunctional crosslinking agent is in the range from 20:1 to 2:1. The metal ion content is from 0 to 110 mol % based on the from α,β-ethylenically unsaturated mono- or dicarboxylic acid incorporated in the form of polymerized units or the salts thereof.

The filler content is from 0 to 70% by weight based on the polymeric fractions of the aqueous composition.

The glass transition temperature of the dispersed particles is in the range of T_{G}=−30 to 110° C. and the mean particle diameter (number average) is in the range from 50 to 400 nm. Both a monomodal and a multimodal particle size distribution may be present.

The aqueous binder can be obtained by mixing the polymer A1 with dissolved polymer A2, the polyfunctional crosslinking agent and, if appropriate, the metal salts and/or fillers. Either polymer A1 or polymer A2 may be initially taken. The mixing can be effected by mixing techniques, for example in a stirred kettle or in a static or dynamic mixer.

Furthermore, the preparation of the binder can also be effected by free radical emulsion polymerization of the polymer A1 with the polymer A2.

In relation to the monomer components of polymer A1, alkyl below are preferably straight-chain or branched C₁-C₂₂-alkyl radicals, in particular C₁-C₁₂-alkyl radicals and particularly preferably C₁-C₆-alkyl radicals, such as methyl, ethyl, n-propyl, n-butyl, sec-butyl, tert-butyl, n-pentyl, n-hexyl, 2-ethylhexyl, n-dodecyl or n-stearyl. Hydroxyalkyl is preferably hydroxy-C₁-C₆-alkyl, it being possible for the alkyl radicals to be straight-chain or branched, and in particular 2-hydroxyethyl, 2- or 3-hydroxypropyl, 2-methyl-2-hydroxypropyl and 4-hydroxybutyl. Cycloalkyl is preferably C₅-C₇-cycloalkyl, in particular cyclopentyl and cyclohexyl.

Aryl is preferably phenyl or naphtyl.

The polymer A1 is a free radical emulsion polymer. For its preparation, all monomers polymerizable by free radical polymerization may be used. In general, the polymer is composed of
from 80 to 100% by weight, preferably from 85 to 99.9% by weight, based on the total weight of the monomers for the polymer, of at least one ethylenically unsaturated main monomer and
from 0 to 20% by weight, preferably from 0.1 to 15% by weight, based on the total weight of the monomers for the polymer, of at least one ethylenically unsaturated comonomer.

The main monomer is preferably selected from
esters of α,β-monoethylenically unsaturated mono-or dicarboxylic acid having preferably 3 to 6 carbon atoms, such as acrylic acid, methacrylic acid, maleic acid, fumaric acid and itaconic acid, with C₁-C₁₂-alkanols, preferably C₁-C₈-alkanols. Such esters are in particular methyl, ethyl, n-butyl, isobutyl, tert-butyl, n-pentyl, isopentyl and 2-ethylhexyl acrylate and/or methacrylate;
vinylaromatic compounds, preferably styrene, α-methylstryne, o-chlorostyrene, vinyltoluenes and mixtures thereof;
vinyl esters of C₁-C₁₈-mono- or dicarboxylic acids, such as vinyl acetate, vinyl propionate, vinyl n-butyrate, vinyl laurate and/or vinyl stearate;
butadiene;
linear 1-olefins, branched 1-olefins or cyclic olefins, such as, for example, ethene, propene, butene, isobutene, pentene, cyclopentene, hexene or cyclohexene. Furthermore, oligoolefins prepared by metallocene catalysis and having a terminal double bond, such as, for example, oligopropene or oligohexene, are also suitable;
acrylonitrile, methacrylonitrile;
vinyl and allyl alkyl ethers having 1 to 40 carbon atoms in the alkyl radical, it being possible for the alkyl radical to carry further substituents, such as one or more hydroxyl groups, one or more amino or diamino groups or one or more alkoxylate groups, such as, for example, methyl vinyl ether, ethyl vinyl ether, propyl vinyl ether and 2-ethylhexyl vinyl ether, isobutyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-n-butylamino)ethyl vinyl ether, methyidiglycol vinyl ether and the corresponding allyl ethers or mixtures thereof.

Particularly preferred main monomers are styrene, methyl methacrylate, n-butyl acrylate, ethyl acrylate, 2-ethylhexyl acrylate, vinyl acetate, ethene and butadiene.

The comonomer is preferably selected from
ethylenically unsaturated mono- or dicarboxylic acids or anhydrides thereof, preferably acrylic acid, methacrylic acid, methacrylic anhydride, maleic acid, maleic anhydride, fumaric acid and/or itaconic acid;
acrylamides and alkyl-substituted acrylamides, such as, for example, acrylamide, methacrylamide, N,N-dimethylacrylamide, N-methylolmethacrylamide, N-tert-butylacrylamide, N-methylmethacrylamide and mixtures thereof;
sulfo-containing monomers, such as, for example, allylsulfonic acid, methallyl-sulfonic acid, styrenesulfonic acid, vinylsulfonic acid, 2-acrylamido-2-methylpropanesulfonic acid, allyloxybenzenesulfonic acid, the corresponding alkali metal and ammonium salts thereof or mixtures thereof and sulfopropyl acrylate and/or sulfopropyl methacrylate;
C₁-C₄-hydroxyalkyl esters of C₃-C₆-mono- or dicarboxylic acids, in particular of acrylic acid, methacrylic acid or maleic acid, or their derivatives alkoxylated with from 2 to 50 mol of ethylene oxide, propylene oxide, butylene oxide or mixtures thereof or esters of C₁-C₁₈-alcohols, alkoxylated with from 2 to 50 mol of ethylene oxide, propylene oxide, butylene oxide or mixtures thereof with said acids, such as, for example, hydroxyethyl acrylate, hydroxyethyl methacrylate, hydroxypropyl acrylate, hydroxypropyl methacrylate, 1,4-butanediol monoacrylate, ethyldiglycol acrylate, methylpolyglycol acrylate (11 EO), (meth)acrylic esters of C₁₃/C₁₅-oxo alcohol reacted with 3, 5, 7, 10 or 30 mol of ethylene oxide or mixtures thereof;
vinylphosphonic acid and salts thereof, dimethyl vinylphosphonate and other phosphorus-containing monomers;
alkylaminoalkyl(meth)acrylates or alkylaminoalkyl(meth)acrylamides or the quaternization products thereof, such as, for example, 2-(N,N-dimethylamino)-ethyl(meth)acrylate or 2-(N,N,N-trimethylammonium)ethyl methacrylate chloride, 3-(N,N-dimethylamino)propyl (meth)acrylate, 2-dimethylaminoethyl(meth)acrylamide, 3-dimethylaminopropyl(meth)acrylamide, 3-trimethylammoniumpropyl(meth)acrylamide chloride and mixtures thereof;
allyl esters of C₁-C₃₀-monocarboxylic acids;
N-vinyl compounds such as, N-vinylformamide, N-vinyl-N-methylformamide, N-vinylpyrrolidone, N-vinylimidazole, 1-vinyl-2-methylimidazole, 1-vinyl-2-methylimidazoline, 2-vinylpyridine, 4-vinylpyridine, N-vinylcarbazole and/or N-vinylcaprolactam;
diallyidimethylammonium chloride, vinylidene chloride, vinyl chloride, acrolein, methacrolein;
monomers comprising 1,3-diketo groups, such as, for example, acetoacetoxy-ethyl(meth)acrylate or diacetone acrylamide, monomers comprising urea groups, such as ureidoethyl(meth)acrylate, acrylamidoglycolic acid, methacryl-amidoglycolate methyl ether;
monomers comprising silyl groups, such as, for example, trimethoxysilylpropyl methacrylate;
monomers comprising glycidyl groups, such as, for example, glycidyl methacrylate.

Particularly preferred comonomers are hydroxyethyl acrylate, hydroxypropyl acrylate, hydroxybutyl acrylate, hydroxyethyl methacrylate, glycidyl methacrylate, acrylamide and mixtures thereof. Hydroxyethyl acrylate and hydroxyethyl methacrylate, glycidyl methacrylate and acrylamide are very particularly preferred, in particular in amounts from 2 to 20% by weight, based on the total monomer A1.

The bi- or polyfunctional monomers are understood as meaning compounds having two or more ethylenically unsaturated groups, such as, for example, diacrylates or dimethacrylates of at least dihydric saturated alcohols, such as, for example, ethylene glycol diacrylate, ethylene glycol dimethacrylate, 1,2-propylene glycol diacrylate, 1,2-propylene glycol dimethacrylate, butanediol 1,4-diacrylate, butanediol 1,4-dimethacrylate, hexanediol diacrylate, hexanediol dimethacrylate, neopentyl glycol diacrylate, neopentyl glycol dimethacrylate, 3-methylpentanediol diacrylate and 3-methylpentanediol dimethacrylate. The acrylates and methacrylates of alchols having more than 2 OH groups can also be used as crosslinking agents, e.g. trimethylolpropane triacrylate or trimethylolpropane trimethacrylate. A further class of bi- or polyfuncational monomers are diacrylates or dimethacrylates of polyethylene glycols or polypropylene glycols having molecular weights of in each case from 200 to 9000.

In addition to the homopolymers of ethylene oxide or propylene oxide, it is also possible to use block copolymers of ethylene oxide and propylene oxide or copolymers of ethylene oxide and propylene oxide which comprise randomly distributed ethylene oxide and propylene oxide units. The oligomers of ethylene oxide or of propylene oxide are also suitable for the preparation of the bi- or polyfunctional monomers, e.g. diethylene glycol diacrylate, diethylene glycol dimethacrylate, triethylene glycol diacrylate, triethylene glycol dimethacrylate, tetraethylene glycol diacrylate and/or tetraethylene glycol dimethacrylate.

Vinyl acrylate, vinyl methacrylate, vinyl itaconate, divinyl adipate, butanediol divinyl ether, trimethylolpropane trivinyl ether, allyl acrylate, allyl methacrylate, pentaerythrityl triallyl ether, triallylsaccharose, pentaallylsaccharose, pentaallylsucrose, methylenebis(meth)acrylamide, divinylethyleneurea, divinylpropyleneurea, divinylbenzene, divinyldioxane, triallyl cyanurate, tetraallylsilane, tetravinylsilane and bis- or polyacryloylsiloxanes (e.g. Tegomere® from Th. Goldschmidt AG). The bi- or polyfunctional monomers can be used in amounts from 0 to 5% by weight, preferably in amounts of from 10 ppm to 5% by weight, based on the monomers to be polymerized.

The polymer A2 comprises from 50 to 99.5% by weight, preferably from 70 to 99% by weight of such incorporated structural elements which are derived from at least one ethylenically unsaturated mono- or dicarboxylic acid. These acids can, if desired, also be present in the polymer partly or completely in the form of a salt. The acidic form is preferred.

The polymer A2 preferably has a water solubility of more than 10 g/l (at 25° C.).

Usable ethylenically unsaturated carboxylic acids have already been mentioned above in relation to the polymer A1. Preferred carboxylic acids are C₃- to C₁₀-monocarboxylic acids and C₄- to C₈-dicarboxylic acids, in particular acrylic acid, methacrylic acid, crotonic acid, fumaric acid, maleic acid, 2-methylmaleic acid and/or itaconic acid. Acrylic acid, methacrylic acid, maleic acid and mixtures thereof are preferred. In the preparation of the polymer A2, it is of course also possible, instead of the acids or together with the acids, to use their anhydrides such as maleic anhydride, acrylic anhydride and methacrylic anhydride.

The polymer A2 furthermore comprises from 0 to 50% by weight, preferably from 0 to 30% by weight, of at least one ethylenically unsaturated compound which is selected from the esters of ethylenically unsaturated monocarboxylic acids and the monoesters and diesters of ethylenically unsaturated dicarboxylic acids with at least one amine comprising hydroxyl groups, incorporated in the form of polymerized units.

The polymer A2 is preferably present as a comb polymer having covalently bonded amine side chains.

Monocarboxylic acids suitable as a component of the esters are the abovementioned C₃- to C₁₀-monocarboxylic acids, in particular acrylic acid, methacrylic acid, crotonic acid and mixtures thereof.

Dicarboxylic acids suitable as a component of the monoesters and diesters of the abovementioned C₄- to C₈-dicarboxylic acids, and in particular fumaric acid, maleic acid, 2-methylmaleic acid, itaconic acid, and mixtures thereof.

The amine having at least one hydroxyl group is preferably selected from secondary and tertiary amines which have at least one C₆- to C₂₂-alkyl, C₆- to C₂₂-alkenyl, aryl-C₆- to C₂₂-alkyl or aryl-C6- to C₂₂-alkenyl radical, it being possible for the alkenyl group to have 1, 2 or 3 non-neighboring double bonds.

The amine is preferably hydroxyalkylated and/or alkoxylated. Alkoxylated amines preferably have one or two alkylene oxide radicals with terminal hydroxyl groups. The alkylene oxide radicals preferably each have from 1 to 100, preferably from 1 to 50, identical or different alkylene oxide units, randomly distributed or in the form of blocks. Preferred alkylene oxides are ethylene oxide, propylene oxide and/or butylene oxide. Ethylene oxide is particularly preferred.

The polymer A2 preferably comprises an incorporated unsaturated compound based on an amine component, which comprises at least one amine of the general formula

R^{c}NR^{a}R^{b}

where
R^{c} is C₆- to C₂₂-alkyl, C₆- to C₂₂-alkenyl, aryl-C₆-C₂₂-alkyl or aryl-C6-C₂₂-alkenyl, it being possible for the alkenyl radical to have 1, 2 or 3 neighboring double bonds,
R^{a} is hydroxy-C₁-C₆-alkyl or a radical of the formula II

—(CH₂CH₂O)ₓ(CH₂CH(CH₃)O)_{y}—H (II)
where,
in the formula II, the sequence of the alkylene oxide units is arbitrary and x and y, independently of one another, are an integer from 0 to 100, preferably 0 to 50, the sum of x and y being >1,
R^{b} is hydrogen, C₁- to C₂₂-alkyl, hydroxy-C₁-C₆-alkyl, C₆- to C₂₂-alkenyl, aryl-C₆-C₂₂-alkyl, aryl-C₆-C₂₂-alkenyl or C₅- to C₈-cycloalkyl, it being possible for the alkenyl radical to have 1, 2 or 3 non-neighboring double bonds, or R^{b} is a radical of the formula III

—(CH₂CH₂O)ᵥ(CH₂CH(CH₃)O)_{w}—H (III)
where,
in the formula III, the sequence of the alkylene oxide units is arbitrary and v and w, independently of one another, are an integer from 0 to 100, preferably from 0 to 50.

R^{c} is preferably C₈- to C₂₀-alkyl or C₈- to C₂₀-alkenyl, it being possible for the alkenyl radical to have 1, 2 or 3 non-neighboring double bonds. R^{c} is preferably the hydrocarbon radical of a saturated or mono- or polyunsaturated fatty acid. Preferred radicals R^{c} are, for example, n-octyl, ethylhexyl, undecyl, lauryl, tridecyl, myristyl, pentadecyl, palmityl, margarinyl, stearyl, palmitoleyl, oleyl and linolyl.

The amine component is particularly preferably an alkoxylated fatty amine or an alkoxylated fatty amine mixture. The ethoxylates are particularly preferred. In particular, alkoxylates of amines based on naturally occurring fatty acids are used, such as, for example, tallow fatty amines, which predominantly comprise saturated and unsaturated C₁₄-, C₁₆- and C₁₈-alkylamines, or cocosamines, which comprise saturated, monounsaturated and diunsaturated C₆-C₂₂-alkylamines, preferably C₁₂-C₁₄-alkylamines. Amine mixtures suitable for the alkoxylation are, for example, varying Armeen® brands from Akzo or Noram® brands from Ceca.

Suitable commercially available alkoxylated amines are, for example, Noramox® brands from Ceca, preferably ethoxylated oleylamines, such as Noramox® 05 (5 EO units), and the products sold under the brand LutensoiRFA by BASF AG.

The incorporation of the abovementioned esters, monoesters and diesters in the form of polymerized units generally results in a pronounced stabilization of the polymer dispersion according to the invention. The polymer dispersions according to the invention reliably retain their colloidal stability of the latex particles on dillution with water, or dillute electrolytes or surfactant solutions.

The esterification for the preparation of the esters, monoesters and diesters described above is effected by conventional processes known to the person skilled in the art. For the preparation of esters of unsaturated monocarboxylic acids, it is possible to use the free acids or suitable derivatives, such as anhydrides, halides, e.g. chlorides, and (C₁- to C₄)-alkyl esters. The preparation of monoesters of unsaturated dicarboxylic acids is preferably effected starting from the corresponding dicarboxylic anhydrides. The reaction is preferably effected in the presence of a catalyst, such as, for example, of a dialkyl titanate, or of an acid, such as sulfuric acid, toluenesulfonic acid or methanesulfonic acid. The reaction is effected in general at reaction temperatures from 60 bis 200° C. According to a suitable embodiment, the reaction is effected in the presence of an inert gas, such as nitrogen. Water formed in the reaction can be removed from the reaction mixture by suitable measures such as by distilling off. The reaction can, if desired, be effected in the presence of conventional polymerization inhibitors. The esterification reaction can be carried out substantially completely or only up to a partial conversion. If desired, one of the ester components, preferably the amine comprising hydroxyl groups, can be used in excess. The proportion of ester formation can be determined by means of infrared spectroscopy.

According to a preferred embodiment, the preparation of the unsaturated esters, monoesters or diesters and the further reaction thereof to give the polymers A2 used according to the invention is effected without intermediate isolation of the esters and preferably in succession in the same reaction vessel.

A reaction product of a dicarboxylic anhydride, preferably maleic anhydride, and one of the above-described amines comprising hydroxyl groups is preferably used for the preparation of the polymers A2.

In addition to the constituents carboxylic acid and ester, monoester and/or diester, the polymer A2 may also comprise from 0 to 20% by weight, preferably from 0.1 to 10% by weight, of other monomers incorporated in the form of polymerized units. Usable monomers are the monomers mentioned in relation to the polymer A1, vinylaromatics, such as styrene, olefins, for example ethylene, or (meth)acrylates, such as methyl(meth)acrylate, ethyl(meth)acrylate, n-butyl(meth)acrylate, 2-ethylhexyl(meth)acrylate and mixtures thereof being particularly preferred.

The preparation of the polymers A2 is preferably effected by free radical mass or solution polymerization. Suitable solvents for the solution polymerization are, for example, water, water-miscible organic solvents such as alcohols and ketones, for example methanol, ethanol, n-propanol, isopropanol, n-butanol, acetone, methyl ethyl ketone, etc., and mixtures thereof. Suitable polymerization initiators are, for example, peroxides, hydroperoxides, peroxodisulfates, percarbonates, peroxoesters, hydrogen peroxide and azo compounds, as described in more detail below for the preparation of the polymer dispersions according to the invention. The polymers A2 can, if desired, be prepared separately and can be isolated and/or purified by conventional methods. The polymers A2 are preferably prepared immediately before the preparation of the polymer dispersions according to the invention and used without immediate isolation for the dispersion polymerization and/or subsequently admixed.

The preparation of the polymers A2 can advantageously also be effected by polymer-analogous reaction. For this purpose, a polymer which comprises from 80 to 100% by weight of at least one ethyleneically unsaturated mono- and/or dicarboxylic acid and from 0 to 20% by weight of the abovementioned other polymers incorporated can be reacted with at least one amine comprising hydroxyl groups.

Suitable ethylenically unsaturated mono- and dicarboxylic acids are those mentioned above as a component of the polymers A1 and A2. Suitable amines which have at least one hydroxyl group are likewise those mentioned above. The acids may be present in the polymer used for the polymer-analogous reaction, if desired, partly or completely in the form of a derivative, preferably of a C₁- to C₆-alkyl ester.

The preparation of the polymers A2 by polymer-analogous reaction is preferably effected in a suitable nonaqueous solvent or in the absence of a solvent. In the case of the reaction in the absence of a solvent, the amine component can, if appropriate, be used in excess in order to serve as a solvent. Solvents which form an azeotrope with water and thus permit simple removal of the water formed in the reaction are preferred. The reaction is preferably effected in the presence of an esterification catalyst as described above. The reaction temperature is preferably in the range from 100 to 200° C. Water formed in the reaction can be removed by suitable measures, such as, for example, by distilling off.

The weight ratio of polymer A1 to polymer A2, based on solids, is preferably in the range from 7:1 to 1:7, and in particular from 3:1 to 1:3.

In addition to the polymers A1 and A2, the latices according to the invention may also comprise from 0 to 50% by weight, preferably from 0.1 to 40% by weight, based on the polymer A2, of at lesat one polyfunctional crosslinking agent. The crosslinking agent may comprise surface-active alkoxylated, preferably ethoxylated or propoxylated, alkylamines. Preferred alkylamines are the alkylamines of the formula R^{c}NR^{a}R^{b}, as defined above, which are also present in the polymer A2, alkylamines of the formula

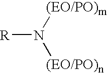

where R is an alkyl, alkenyl or alkylvinyl radical having at least 6 carbon atoms and m and n, indepedently of one another, are ≧1, being particularly preferred. Preferred radicals R have 8 to 22 carbon atoms.

The alkoxylated alkylamines present in the polymer A2 and the additional alkylamine crosslinking agents may be identical or different compounds.

If desired, the polymer dispersion according to the invention may comprise further crosslinking agents, for example an amine or amide crosslinking agent having at least two hydroxyl groups. Suitable crosslinking agents are in particular the alkanolamines disclosed in DE 19729 161, which are hereby incorporated by reference.

Further suitable crosslinking agents are preferably β-hydroxyalkylamines of the formula

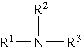

where R¹ is an H atom, a C₁- to C₁₀-alkyl group, a C₁- to C₁₀-hydroxyalkyl group or a radical of the formula IV

—(CH₂CH₂O)ₓ(CH₂CH(CH₃)O)_{y}—H (IV)

where,

in the formula IV, the sequence of the alkylene oxide units is arbitrary and x and y, independently of one another, are an integer from 0 to 100, the sum of x and y being >1 and R² and R³ independently of one another being a C₁- to C₁₀-hydroxyalkyl group.

R² and R³, independently of one another, are particularly preferably a C₂- to C₅-hydroxyalkyl group and R¹ is an H atom, a C₁- to C₅-alkyl group or a C₂- to C₅-hydroxyalkyl group.

Diethanolamine, triethanolamine, diisopropanolamine, triisopropanolamine, methyldiethanolamine, butyldiethanolamine and methyldiisopropanolamine, are particularly preferred, in particular triethanolamine.

Further preferred β-hydroxyalkylamines are the amines disclosed as component A in DE 196 21 573, which are hereby incorporated by reference. These preferably include linear or branched aliphatic compounds which have, per molecule, at least two functional amino groups of the type (a) or (b)

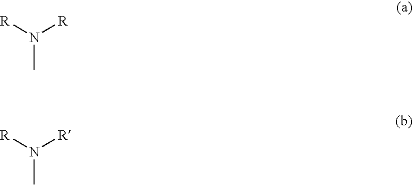

where R is hydroxyalkyl and R′ is alkyl, preferably a compound of the formula I

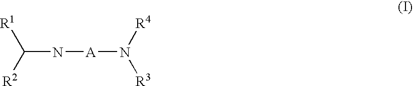

where
A is C₂-C₁₈-alkylene which is optionally substituted by one or more groups which, independently of one another, are selected from alkyl, hydroxyalkyl, cycloalkyl, OH and NR⁶R⁷, where R⁶ and R⁷ independently of one another are H, hydroxyalkyl or alkyl, and which is optionally interrupted by one or more oxygen atoms and/or NR⁵ groups, where R⁵ is H, hydroxyalkyl, (CH₂)ₙNR⁶R⁷, where n is from 2 to 5 and R⁶ and R⁷ have the abovementioned meanings, or alkyl which in turn may be interrupted by one or more NR⁵ groups, where R⁵ has the abovementioned meanings, and/or substituted by one or more NR⁶R⁷ groups, where R⁶ and R⁷ have the abovementioned meanings;
   or A is a radical of the formula:

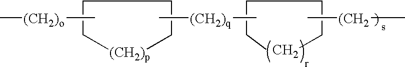

where
o, q and s independently of one another, are 0 or an integer from 1 to 6,
p and r independently of one another are 1 or 2 and
t is 0, 1 or 2,
it being possible for the cycloaliphatic radicals also to be substituted by 1, 2 or 3 alkyl radicals, and
R¹, R² and R³ and R⁴ independently of one another are H, hydroxyalkyl, alkyl or cycloalkyl.

Preferred higher-functional β-hydroxyalkylamines are in particular at least diethoxylated amines having a molecular weight of less than 1000 g/mol, such as, for example, diethanolamine, triethanolamine and ethoxylated diethylenetriamine, preferably stoichiometrically ethoxylated diethylenetriamine, i.e. diethylenetriamine, in which all NH hydrogen atoms are on average monoethoxylated.

Suitable additional crosslinking agents are also β-hydroxyalkylamides, preferably the β-hydroxyalkylamides mentioned in U.S. Pat. No. 5,143,582 and of the formula

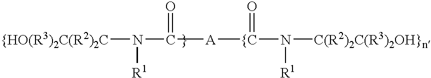

The β-hydroxyalkylamides of the above formula, in which R¹ is hydrogen, a short-chain alkyl group or HO(R³)₂C(R²)₂C—, n and n′ are each one, -A- is a —(CH₂)ₘ— group, m is from 0 to 8, preferably from 2 to 8, R² is in each case hydrogen, and one of the R³ groups is in each case hydrogen and the other is hydrogen or C₁-C₅-alkyl, are particularly preferred. Bis[N,N-di(2-hydroxyethyl)]adipamide is particularly preferred.

The addition of the crosslinking agent generally results in better curing of the compositions according to the invention at a given curing temperature or complete curing at a low temperature in a specified curing time. The proportion by weight of the crosslinking agent relative to the sum of polymers A1 and A2 is from 0 to 30% by weight, preferably from 0.1 to 15% by weight.

Furthermore, a reaction accelerator can be added to the polymer dispersions according to the invention. Phosphorus-containing compounds, in particular hypophosphorous acid and the alkali metal and alkaline earth metal salts thereof or alkali metal tetrafluoroborates, are preferred. Salts of Mn(II), Ca(II), Zn(II), Al(III), Sb(III) or Ti(IV) or strong acids, such as para-toluenesulfonic acid, trichloroacetic acid and chlorosulfonic acid, may also be added as reaction accelerators. The proportion by weight of the reaction accelerator relative to the sum of polymers A1 and A2 is 0.1 to 5% by weight, preferably from 0.1 to 2% by weight.

Particularly preferred compositions of the polymer dispersions according to the invention are

from 30 to 50% by weight of polymer A1,

from 70 to 50% by weight of polymer A2 and, if appropriate,

from 0 to 10% by weight of surface-active alkoxylated alkylamine,

from 0 to 20% by weight of crosslinking agents comprising hydroxyl groups,

from 0 to 5% by weight of reaction accelerator.

The invention furthermore relates to a process for the preparation of an aqueous polymer dispersion as described above, at least one ethylenically unsaturated monomer being converted by free radical emulsion polymerization into a polymer A1, and the polymerization being effected in the presence of at least one polymer A2.

The preparation of the polymer dispersion according to the invention is preferably effected by aqueous emulsion polymerization, a batchwise, a semicontinuous or a continuous procedure being possible. It proved to be advantageous to meter the polymer A2 together with the monomers of the polymer A1 in the form of an emulsion feed into the reaction vessel. If desired, the monomers forming the polymer A1, and the polymer A2, can be fed to the reaction vessel partly or completely via two or more separate feeds. The monomers can be fed to the reaction vessel both in preemulsified and in non-preemulsified form. According to a preferred embodiment, at least a part of the polymer A2 is fed to the reaction vessel together with at least one monomer component of A1. Advantageously, aqueous polymer dispersions which have a lower viscosity than conventional dispersions are generally obtained. The polymer A2 can be initially taken partly or completely in the reactor. The use of a defined amount of a seed latex initially taken in the reactor is advantageous for the polymer dispersions according to the invention for establishing a particle size distribution in a controlled manner. From 0 to 25% by weight, preferably from 0.1 to 10% by weight, based on the polymer A1, of a suitable seed latex may be used in this case.

The preparation of the polymer dispersion is effected as a rule in water as dispersing medium. However, water-miscible organic solvents, such as alcohols and ketones, for example methanol, ethanol, n-propanol, isopropanol, n-butanol, acetone or methyl ethyl ketone, may also be present up to a proportion of about 30% by volume.

The polymer A1 can therefore be prepared by aqueous emulsion polymerization in the presence of the polymer A2 and, if present, preferably in the presence of a surface-active amine, as described above.

The polymerization is preferably carried out in the presence of compounds forming free radicals (initiators). Preferably from 0.05 to 10, particularly preferably from 0.2 to 5% by weight, based on the monomers used in the polymerization, of these compounds are required.

Suitable polymerization initiators are, for example, peroxides, hydroperoxides, peroxodisulfates, percarbonates, peroxoesters, hydrogen peroxide and azo compounds. Examples of initiators, which may be water-soluble or water-insoluble, are hydrogen peroxide, dibenzoyl peroxide, dicyclohexyl peroxydicarbonate, dilauroyl peroxide, methyl ethyl ketone peroxide, di-tert-butyl peroxide, acetylacetone peroxide, tert-butyl hydroperoxide, cumene hydroperoxide, tert-butyl perneodecanoate, tert-amyl perpivalate, tert-butyl perpivalate, tert-butyl perneohexanoate, tert-butyl per-2-ethylhexanoate, tert-butyl perbenzoate, lithium, sodium, potassium and ammonium peroxydisulfate, azobisisobutyronitrile, 2,2′-azobis(2-amidinopropane)dihydrochloride, 2-(carbamoylazo)isobutyronitrile and 4,4-azobis(4-cyanovaleric acid). Known redox initiator systems such as, for example, H₂O₂/ascorbic acid or tert-butyl hydroperoxide/sodium hydroxymethanesulfinate, can also be used as polymerization initiators.

The initiators can be used alone or as a mixture with one another, for example, mixtures of hydrogen peroxide and sodium peroxydisulfate. For the polymerization in aqueous medium, water-soluble initiators are preferably used.

In order to prepare polymers having a low average molecular weight, it is often expendient to carry out the copolymerization in the presence of regulators. Conventional regulators, such as, for example, organic compounds comprising SH groups such as 2-mercaptoethanol, 2-mercaptopropanol, mercaptoacetic acid, tert-butyl mercaptan, n-octyl mercaptan, n-dodecyl mercaptan and tert-dodecyl mercaptan, hydroxylammonium salts, such as hydroxylammonium sulfate, formic acid, sodium bisulfite or isopropanol, can be used for this purpose. The polymerization regulators are used in general in amounts of from 0.05 to 5% by weight, based on the monomers.

In order to prepare relatively high molecular weight copolymers, it is often expedient to work in the presence of crosslinking agents during the polymerization. Such crosslinking agents are compounds having two or more ethylenically unsaturated groups, such as, for example, diacrylates or dimethacrylates of at least dihydric saturated alcohols, such as, for example, ethylene glycol diacrylate, ethylene glycol dimethacrylate, 1,2-propylene glycol diacrylate, 1,2-propylene glycol dimethacrylate, butanediol 1,4-diacrylate, butanediol 1,4-dimethacrylate, hexanediol diacrylate, hexanediol dimethacrylate, neopentyl glycol diacrylate, neopentyl glycol dimethacrylate, 3-methylpentanediol diacrylate and 3-methylpentanediol dimethacrylate. The acrylates and methacrylates of alcohols having more than 2 OH groups can also be used as crosslinking agents, e.g. trimethylolpropane triacrylate or trimethylolpropane trimethacrylate. A further class of crosslinking agents comprises diacrylates or dimethacrylates of polyethylene glycols or polypropylene glycols having molecular weights of in each case from 200 to 9000.

In addition to the homopolymers of ethylene oxide or of propylene oxide, block copolymers of ethylene oxide and propylene oxide or copolymers of ethylene oxide and propylene oxide, which comprise the ethylene oxide and propylene oxide units distributed in random form, may also be used. The oligomers of ethylene oxide or of propylene oxide are also suitable for the preparation of the crosslinking agents, e.g. diethylene glycol diacrylate, diethylene glycol dimethacrylate, triethylene glycol diacrylate, triethylene glycol dimethacrylate, tetraethylene glycol diacrylate and/or tetraethylene glycol dimethacrylate.

Suitable crosslinking agents are furthermore vinyl acrylate, vinyl methacrylate, vinyl itaconate, divinyl adipate, butanediol divinyl ether, trimethylolpropane trivinyl ether, allyl acrylate, allyl methacrylate, pentaerythrityl triallyl ether, triallylsaccharose, pentaallylsaccharose, pentaallylsucrose, methylenebis(meth)acrylamide, divinylethyleneurea, divinylpropyleneurea, divinylbenzene, divinyldioxane, triallyl cyanurate, tetraallylsilane, tetravinylsilane and bis- or polyacrylsiloxanes (e.g. Tegomere® from Th. Goldschmidt AG). The crosslinking agents can be used in amounts of from 0 to 5, preferably in amounts of from 10 ppm to 5% by weight, based on the monomers to be polymerized.

In addition to said constituents the compositions according to the invention may comprise conventional additives, depending on the intended use.

The components which, if appropriate, are additionally present in the composition according to the invention are added after the end of the emulsion polymerization.

The compositions according to the invention may furthermore comprise conventional additives, depending on the intended use. For example they may comprise bactericides or fungicides. In addition, they may comprise water repellents for increasing the water resistance of the substrates treated. Suitable water repellents are conventional aqueous paraffin dispersions or silicones. Furthermore, the compositions may comprise wetting agents, thickeners, plasticizing agents, retention aids, pigments and fillers.

Finally, the compositions according to the invention may comprise conventional fireproofing agents, such as, for example aluminum silicates, aluminum hydroxides, borates and/or phosphates.

The compositions frequently also comprise coupling reagents, such as alkoxysilanes, for example 3-aminopropyltriethoxysilane, soluble or emulsifiable oils as lubricants and dust binders and wetting assistants.

The compositions according to the invention may also be used as a mixture with other binders such as, for example, urea-formaldehyde resins, melamine-formaldehyde resins or phenol-formaldehyde resins, and with epoxy resins.

The compositions according to the invention are formaldehyde-free. Formaldehyde-free means that the compositions according to the invention comprise no substantial amounts of formaldehyde and no substantial amounts of formaldehyde are liberated even during drying and/or curing. In general, the compositions comprise <100 ppm of formaldehyde. They permit the production of moldings having a short curing time and impart excellent mechanical properties to the moldings.

The heat-curable formaldehyde-free compositions according to the invention are substantially uncrosslinked and therefore thermoplastic prior to use. If required, however, a small degree of precrosslinking of the polymer A1 can be established, for example by using monomers having two or more polymerizable groups.

The dispersions according to the invention substantially comprise finely divided emulsion polymer particles of A1 and an aqueous phase comprising the polymer A2 and, if appropriate, amine which is separately added or has not reacted in the esterification, and, if appropriate, further water-soluble additives, e.g. crosslinking agents.

The formation of superstructures, such as, for example, of lyotropic phases formed by lamellar or spherical aggregates, may take place in the aqueous phase.

The monomer composition is in general chosen so that a glass transition temperature Tg in the range from −60° C. to +150° C. results for the polymer A1. The glass transition temperature Tg of the polymer can be determined in a known manner, for example by means of differential scannning calorimetry (DSC). The Tg can also be calculated approximately by means of the Fox equation. According to Fox T. G., Bull. Am. Physics Soc. 1,3, page 123 (1956) the following is true: 1/Tg=x₁/Tg₁+x₂/Tg₂+ . . . +xₙ/Tgₙ, where xₙ is the mass fraction (% by weight/100) of the monomer and Tgₙ is the glass transition temperature in Kelvin of the homopolymer of the monomer. Tg values for homopolymers are mentioned in Polymer Handbook, 3rd Edition, J. Wiley & Sons, New York (1989). For the further processing to give insulating fiberboards, polymers A1 having a glass transition temperature in the range of 60 to 120° C. are preferably used. For the further processing to give cork products, the glass transition temperature is preferably in a range from −50 to 90° C.

The polymer dispersions according to the invention are finely divided, stable latices. The weight average particle size of the latex particles is from about 10 to 1500 mm, preferably from 20 to 1000 mm, particularly preferably from 30 to 500 mm, measured with the aid of an analytical ultracentrifuge (AUC).

The polymer dispersions according to the invention can be infinitely dilluted with water or dillute salt or surfactant solutions without coagulation of the latex particles occurring. The compositions according to the invention have a content of nonvolatile fractions (solids content) in the range from about 20 to 75% by weight, preferably from 25 to 65% by weight. The viscosity (at a solids content of 40% by weight) is in general in a range from about 10 to 4000 mPas, measured using a rotational viscometer according to DIN 53019 at 23° C. and a shear weight of 250 s⁻¹.

Furthermore, the compositions according to the invention may comprise assistants customary in coating and impregnating technology. Examples of these are finely divided inert fillers, such as aluminum silicates, quartz, precipitated or pyrogenic silica, gypsum and barite, talc, dolomite or calcium carbonate; color-imparting pigments, such as titanium white, zinc white, iron oxide black etc., foam enhibitors such as modified dimethylpolysiloxanes, and adhesion promoters and preservatives.

The components of the composition according to the invention are present in the coating material in general in an amount from 1 to 65% by weight. The proportion of the inert fillers is in general from 0 to 85% by weight, and the proportion of water is at least 10% by weight.

The binders according to the invention are suitable as binders for substrates, such as, for example, for the production of fiber webs.

The fiber webs may consist of natural and/or synthetic fibers. Examples of natural fibers are cellulose fibers of different origin, such as pulp and viscose staple fibers, and fibers of cotton, hemp, jute, sisal and wood, wool, and mixtures of at least two of said fiber types. Preferably used fibers from the group of fibers are fibers of jute, sisal and wood. Examples of synthetic fibers are vicsose, polyester, polyamide, polypropylene, polyethylene, polyacrylonitrile and polyvinyl chloride fibers, and carbon fibers, glass fibers, ceramic fibers and mineral fibers, and mixtures of at least two of said fiber types. Polyester fibers and mixtures of polyester fibers and glass fibers are preferably used for the production of the bonded fiber webs. Polyester fibers can be obtained from recylcled material by melt spinning and can be used for the production of a substrate web. These webs may for example consist of staple fibers or of spun fibers and mixtures of these fiber types.

They are known to be produced mechanically by needle-punching or water jet consolidation of a wet-laid or air-laid web and/or by chemical consolidation with polymeric binders. For the production of bonded fiber webs, for example, at least one binder in an amount from 0.5 to 30, preferably from 15 to 20% by weight, based on the solids content of the binders and sheet-like fiber structures, such as webs, is used. The binder serves for consolidating the webs. It can be applied, for example, by spraying, immersion, impregnation or slop-padding or by treatment of the fiber structure with a foam.

The webs have, for example, a weight per unit area of from 10 to 700 g/m², preferably from 50 to 500 g/m². In general, the weight per unit area of the still unconsolidated webs is from 75 to 300 g/m².

The webs impregnated with a binder are heated to temperatures in the range from 130° C. to 230° C., preferably from 150 to 210° C. for consolidation. The duration of the heating depends substantially on the temperature, the water content and the respective fibers of which the web consists. In general, the webs impregnated or coated with at least one binder are heated for from 0.5 to 5, preferably from 1.5 to 3, minutes. During the heating, steam initially escapes and, simultaneously therewith or subsequently, the heat-curable binder is crosslinked.

When used as binders for fiber webs, the binders according to the invention may also comprise additives, such as silicates, silicones, boron-containing compounds, lubricants and wetting assistants.

The invention also relates to the use of bonded fiber webs, which are consolidated with the polymeric binder, as substrate material for bituminized roofing sheets, and roofing sheets comprising the polymeric binder.

The roofing sheets are obtained by coating or impregnating the consolidated webs described above with bitumen on both sides or one side. For example a sheet of a suitable web is passed through a bitumen melt and the sheet impregnated in this manner is pressed. This process can be repeated once or several times. The bitumen coat, based on the consolidated web, is, for example, from 25:1 to 2:1, preferably from 15:1 to 5:1% by weight, based on the weight per unit area.

The roofing sheets according to the invention surprisingly have a higher heat distortion resistance and lower water absorption in combination with comparable strength in comparison with the known roofing sheets.

A further use, according to the invention, of the binders is the use for the production of filter materials, in particular of filter papers or filter fabrics. Fabric materials may be, for example, cellulose, cotton, polyester, polyamide, PE, PP, glass webs or glass wool. It may be advisable to adjust the aqeuous polymer solutions to a pH of from 2 to 8, in particular from 3.0 to 6.5 before the application to the corresponding paper or fabric by addition of various inorganic or organic bases. Suitable bases are, inter alia, triethanolamine, diethanolamine, monoethanolamine, hydroxyalkylamines, ammonia, organic mono- or polyfunctional amines, alcoholates and metal alkyl compounds but also inorganic bases, such as, for example, sodium hydroxide solution or potassium hydroxide. By adjusting the pH to the stated range of values, inter alia, the decrease in the bursting strength after storage or thermal load and hence high heat distortion resistance is achieved.

The application of the polymer solution to be used according to the invention to the filter materials, i.e. inter alia to filter paper or filter fabric, is preferably effected by the so-called impregnation method or by spraying on. The aqueous polymer solutions are applied to the filter materials by coating. It is advisable, after the coating of the filter materials with the aqueous polymer solutions, to heat, i.e. to cure, them for a further 0.1 to 60 minutes, in particular from 1 to 60 minutes, at temperatures from 100 to 250° C., in particular from 110 to 220° C.

The use, according to the invention, of the aqueous polymer solution as a binder for filter materials results in the treated filter materials having, inter alia, increased mechanical stability (higher strength and bursting strength), in particular, after storage in a humid climate and at elevated temperature. Furthermore, the use, according to the invention, of the aqueous binders results in the filter materials obtained being characterized, inter alia, by a high chemical resistance, for example to solvents, without the permeability (pore size) of the filter material being influenced. By using the aqueous polymer solutions, it is also observed that they impart a high strength (dry breaking strength) to the filter materials after drying, but the filter materials can still be readily subjected to deformation by folding, fluting or pleating even after the drying and below the curing temperature of the aqueous polymer solutions. After the subsequent thermal curing (heating), the polymer solutions impart high dimensional stability to the filter materials, substantially filter papers or filter fabrics, which are obtained thereby and are likewise according to the invention. This property permits the production of semifinished products and hence the separation of the production process into individual production steps decoupled from one another.

Further uses according to the invention are the use of the aqueous polymer solutions as binders for cork, cork webs, cork mats or cork sheets, as wallpaper substrate webs, as nonwovens for cleaning and wiping cloths or as inliners or substrate material for floor coverings, such as, for example, comprising PVC.

Production of Nonwovens

Polyester spunbonded fabric having a weight per unit area of about 150 g/m² are impregnated with the binder in a HVF impregnating unit having a padding mangle from

Mathis (rubber roll Shore A=85°/steel roll). The raw spunbonded fabric having a length of 40 cm and a width of 37 cm is passed in the longitudinal direction through the impregnating bath and squeezed off between two vertically mounted rolls (rubber/steel). The impregnating liquor has a solids content of 15% by weight. The wet coat in the case of a 15% strength by weight liquor is about 130-135%.

The drying of the spunbonded fabric is then effected in an LTV laboratory dryer with needle frame from Mathis. The impregnated spunbonded fabric is placed on a hinged needle frame, fixed and dried in an oven for 3 min at 200° C. and cured.

The resulting solid coat is 20% by weight (±0.5% by weight)

Application in %=mass of binder (solid)/mass of fibers

Testing of the Nonwovens

For characterizing the water absorption of the web, web strips are immersed 25 mm into a test liquid (0.1% by weight methylene blue in water) for a duration of 10 min and then scraped off between two filter papers. After drying at room temperature, the rise weight of the test liquid is determined.

The determination of the tensile strength and elongation at break at room temperature is effected according to DIN 52123 with the aid of a tearing machine from Frank (model 81565). The maximum tensile force value is obtained by dividing the resulting tensile strength by the weight per unit area of the nonwoven.

The heat distortion resistance of PET nonwovens is characterized by tensile stress experiments by means of a tearing machine from Zwick with integrated thermostated chamber (T=200° C.). For each measurment, 5 test specimens of 50×210 mm (longitudinal direction) each are prepared. The clamping length is 100 mm and the take-off speed is 150 mm/min. At T=200° C. the elongation of the nonwoven is determined with increasing tensile force. The elongation determined for the 5 test specimens is stated for defined tensile forces.

### EXAMPLE A

X1 g of water, Y1 g of 43% strength acrylate resin solution A¹ and 5% of feed 2 are initially taken in a 2.51 glass vessel and heated to 85° C. 10% of feed 1 are then added. After 2 min the remainder of feed 1 is metered in at this temperature in 3.5 h and the remainder of feed 2 in 3 h. Thereafter, polymerization is effected for a further 1 ¹ Comparative example from DE10224922

h at this temperature and the reaction mixture is cooled. The dispersion thus prepared has a solids content of 25% and a pH of 2.5. Thereafter, 18% of triethanolamine, based on acrylate resin solution (solid), are added.

Initially Taken

mixture:

| | Ex. 1 | Ex. 2 | Ex. 3 | Ex. 4 | Ex. 5 |
|---|---|---|---|---|---|
| X1 | 894 | 894 | 894 | 761 | 1026 |
| Y1 | 465 | 465 | 465 | 698 | 233 |

| | Ex. 6 | Ex. 7 | Ex. 8 | Ex. 9 |
|---|---|---|---|---|
| X1 | 413 | 413 | 894 | 894 |
| Y1 | 698 | 698 | 465 | 465 |

Composition of feed 1 in g:

| | |
|---|---|
| 7% strength sodium persulfate | 57.1 |

Composition of feed 2 in g:

| | Ex. 1 | Ex. 2 | Ex. 3 | Ex. 4 | Ex. 5 |
|---|---|---|---|---|---|
| Butyl acrylate | 86 | 120 | 120 | 43 | 129 |
| Styrene | 68 | 49 | 49 | 34 | 102 |
| Acrylonitrile | 30 | 15 | 15 | 15 | 45 |
| Allyl methacrylate | 2 | 2 | 2 | 1 | 3 |
| Glycidyl methacrylate | 10 | 10 | | 5 | 15 |
| 2-Hydroxyethyl acrylate | | | 10 | | |
| Methacrylic acid | 4 | 4 | 4 | 2 | 6 |

| | Ex. 6 | Ex. 7 | Ex. 8 | Ex. 9 |
|---|---|---|---|---|
| Butyl acrylate | 129 | 129 | 120 | 120 |
| Styrene | 111 | 117 | 34 | 49 |
| Acrylonitrile | 45 | 45 | 30 | 15 |
| Allyl methacrylate | 3 | 3 | 2 | 2 |
| Glycidyl methacrylate | 6 | | 10 | 10 |
| 2-Hydroxyethyl acrylate | | | | |
| Methacrylic acid | 6 | 6 | 4 | 4 |

### EXAMPLE B

X2 g of water, Y2 g (=50%) of a 50% strength acrylate resin solution B² and 5% of feed 2 are initially taken in a 2.5 l glass vessel having an anchor stirrer and heated to 85° C. 10% of feed 1 are then added. After 2 min, the remainder of feed 1 is metered in at this temperature in 3.5 h and the remainder of feed 2 in 3 h. Thereafter, polymerization is effected for a further 1 h at this temperature and the reaction mixture is cooled. The dispersion thus prepared has a solids content of 25% and a pH of 2.5. ² Corresponds to binder G from DE 19606394

Initially Taken Mixture:

| | Ex. 10 | Ex. 11 | Ex. 12 | Ex. 13 | Ex. 14 |
|---|---|---|---|---|---|
| X2 | 989 | 739 | 864 | 864 | 86 |
| Y2 | 250 | 750 | 500 | 500 | 500 |

Composition of feed 1 in g

| | |
|---|---|
| 7% strength sodium persulfate | 57.1 |

Composition of feed 2 in g:

| | Ex. 10 | Ex. 11 | Ex. 12 | Ex. 13 | Ex. 14 |
|---|---|---|---|---|---|
| Butyl acrylate | 187.5 | 62.5 | 124 | 125 | 125 |
| Styrene | 105 | 35 | 70 | 50 | 50 |
| Acrylonitrile | 37.5 | 12.5 | 25 | | 25 |
| Allyl methacrylate | 3.75 | 1.25 | 2.5 | | |
| Glycidyl methacrylate | | | | | |
| 2-Hydroxyethyl acrylate | 37.5 | 12.5 | 25 | 25 | 25 |
| Methacrylic acid | 3.75 | 1.25 | 2.5 | | |
| Methyl methacrylate | | | | 50 | 25 |

### EXAMPLE C

230 g of water, 17.6 g of 33% strength by weight polystyrene seed having a particle diameter of 28 nm and 10% by weight of feed 2 are initially taken in a 2.5 l glass vessel having an anchor stirrer and heated to 85° C. 18 g of a 7% strength by weight aqueous sodium persulfate solution are then added. After 2 min, feed 1 and the remainder of feed 2 are metered in at this temperature in the course of 3 h. Thereafter, polymerization is effected for a further 1 h at this temperature and reaction mixture is cooled. The dispersion thus prepared has a solids content of 52% by weight and a pH of 3.7.

Composition of feed 1 in g:

| | |
|---|---|
| 7% strength by weight aqueous sodium persulfate solution | 78.6 |

Composition of feed 2 in g:

| | Disp. 1 | Disp. 2 | Disp. 3 | Disp. 4 | Disp. 5 |
|---|---|---|---|---|---|
| n-Butyl acrylate | 562.6 | 417.1 | 417.1 | 417.1 | 219 |
| Styrene | 184.3 | 354 | 354 | 329.8 | 170 |
| Acrylonitrile | 145.5 | 131 | 150.4 | 145.5 | 75 |
| Allyl methacrylate | 9.7 | 9.7 | 9.7 | 9.7 | |
| Butanediol diacrylate | | | | | 1 |
| Glycidyl methacrylate | 48.5 | | | 48.5 | 25 |
| 2-Hydroxyethyl acrylate | | 38.8 | 19.4 | | |
| Methacrylic acid | 19.4 | 19.4 | 19.4 | 19.4 | |
| Acrylic acid | | | | | 10 |
| Water | 463.1 | 463.1 | 463.1 | 463.1 | 200.7 |
| Disponil ® FES 77 | | | | | |
| 15% strength | | | | | |
| Steinapol ® NLS | 129.3 | 129.3 | 129.3 | 129.3 | 66.7 |
| 15% strength | | | | | |
| | | | | | Disp. |
| | Disp. 6 | Disp. 7 | Disp. 8 | Disp. 9 | 10 |
| n-Butyl acrylate | 279.5 | 416 | 416 | 416 | 416 |
| Styrene | 221 | 323 | 323 | 323 | 275 |
| Acrylonitrile | 97.5 | 142.5 | 95 | 47.5 | 95 |
| Allyl methacrylate | 6.5 | | | | |
| Butanediol diacrylate | | 1.9 | 1.9 | 1.9 | 1.9 |
| Glycidyl methacrylate | 32.5 | | | | |
| 2-Hydroxypropyl | | 47.5 | 95 | 142.5 | 142.5 |
| acrylate | | | | | |
| Methacrylic acid | 13 | | | | |
| Acrylic acid | | 19 | 19 | 19 | 19 |
| Water | 219.3 | 385 | 385 | 385 | 385 |
| Disponil ® FES 77 | | 47.5 | 47.5 | 47.5 | 47.5 |
| 15% strength | | | | | |
| Steinapol ® NLS | 86.7 | 126.7 | 126.7 | 126.7 | 126.7 |
| 15% strength | | | | | |
| | Disp. | Disp. | Disp. | Disp. | Disp. |
| | 11 | 12 | 13 | 14 | 15 |
| n-Butyl acrylate | 416 | 417 | 708 | 563 | 417 |
| Styrene | 275 | 330 | 39 | 184.3 | 378.3 |
| Acrylonitrile | 142.5 | 145.5 | 145.5 | 145.5 | 97 |
| Allyl methacrylate | | 9.7 | 9.7 | 9.7 | 9.7 |
| Butanediol diacrylate | 1.9 | | | | |
| Glycidyl methacrylate | | 48.5 | 48.5 | 48.5 | 48.5 |
| 2-Hydroxypropyl | 95 | | | | |
| acrylate | | | | | |
| Methacrylic acid | | 19.4 | 19.4 | 19.4 | 19.4 |
| Acrylic acid | 19 | | | | |
| Water | 385 | 463.1 | 463.1 | 463.1 | 463.1 |
| Disponil ® FES 77 | 47.5 | | | | |
| 15% strength | | | | | |
| Steinapol ® NLS | 126.7 | 129.3 | 129.3 | 129.3 | 129.3 |
| 15% strength | | | | | |
| | Disp. | Disp. | Disp. | Disp. | Disp. |
| | 16 | 17 | 18 | 19 | 20 |
| n-Butyl acrylate | 417 | 417 | 417 | 417 | 320 |
| 2-Ethylhexyl acrylate | | | | | 97 |
| Styrene | 402.6 | 426.8 | 305.6 | 281.3 | 329.8 |
| Acrylonitrile | 72.8 | 48.5 | 145.5 | 145.5 | 145.5 |
| Allyl methacrylate | 9.7 | 9.7 | 9.7 | 9.7 | 9.7 |
| Glycidyl methacrylate | 48.5 | 48.5 | 72.8 | 97 | 48.5 |
| Methacrylic acid | 19.4 | 19.4 | 19.4 | 19.4 | 19.4 |
| Water | 463.1 | 463.1 | 463.1 | 463.1 | 463.1 |
| Disponil ® FES 77 | | | | | |
| 15% strength | | | | | |
| Steinapol ® NLS | 129.3 | 129.3 | 129.3 | 129.3 | 129.3 |
| 15% strength | | | | | |

| | Disp. 21 | Disp. 22 |
|---|---|---|
| n-Butyl acrylate | 223.1 | 417.1 |
| 2-Ethylhexyl acrylate | 194 | |
| Styrene | 329.8 | 339.5 |
| Acrylonitrile | 145.5 | 145.5 |
| Allyl methacrylate | 9.7 | |
| Glycidyl methacrylate | 48.5 | 48.5 |
| Methacrylic acid | 19.4 | 19.4 |
| Water | 463.1 | 463.1 |
| Disponil ® FES 77 15% strength | | |
| Steinapol ® NLS 15% strength | 129.3 | 129.3 |

The dispersions are subjected to a soaping aftertreatment with additional emulsifier. Mixtures of the dispersions with acrylate resin solution A³, B⁴, C⁵ are carried out in a 1.0 l glass vessel having a magnetic stirrer by initially taking the acrylate resin solution and adding the dispersion in the course of 1 min. ³ corresponds to binder C from DE 19606394⁴ corresponds to binder G from DE 19606394⁵ Comparative example from DE 10224922

| | Amount of | | | |
|---|---|---|---|---|
| | acrylate | | | |
| | resin | Disper- | | |
| Exam- | sol. [%] | sion⁶ | Additional | |
| ple | (Type) | No. | emulsifier | Additive |
| 15 | 50 (B) | 1 | Disponil ® FES 77⁷ | — |
| 16 | 50 (B) | 2 | Disponil ® FES 77 | — |
| 17 | 50 (B) | 3 | Disponil ® FES 77 | — |
| 18 | 50 (B) | 4 | Disponil ® FES 77 | — |
| 19 | 50 (B) | 5 | Disponil ® FES 77 | — |
| 20 | 50 (B) | 6 | Disponil ® FES 77 | — |
| 21 | 50 (B) | 7 | Disponil ® FES 77 | — |
| 22 | 50 (B) | 8 | Disponil ® FES 77 | — |
| 23 | 50 (B) | 9 | Disponil ® FES 77 | — |
| 24 | 50 (B) | 10 | Disponil ® FES 77 | — |
| 25 | 50 (B) | 11 | Disponil ® FES 77 | — |
| 26 | 50 (B) | 12 | Disponil ® FES 77 | — |
| 27 | 50 (B) | 13 | Disponil ® FES 77 | — |
| 28 | 50 (B) | 14 | Disponil ® FES 77 | — |
| 29 | 50 (B) | 15 | Disponil ® FES 77 | — |
| 30 | 50 (B) | 16 | Disponil ® FES 77 | — |
| 31 | 50 (B) | 17 | Disponil ® FES 77 | — |
| 32 | 50 (B) | 18 | Disponil ® FES 77 | — |
| 33 | 50 (B) | 19 | Disponil ® FES 77 | — |
| 34 | 50 (B) | 20 | Disponil ® FES 77 | — |
| 35 | 50 (B) | 21 | Disponil ® FES 77 | — |
| 36 | 50 (B) | 22 | Disponil ® FES 77 | — |
| 37 | 60 (A) | 5 | Disponil ® FES 77 | — |
| 38 | 55 (A) | 5 | Disponil ® FES 77 | — |
| 39 | 50 (A) | 5 | Disponil ® FES 77 | — |
| 40 | 45 (A) | 5 | Disponil ® FES 77 | — |
| 41 | 40 (A) | 5 | Disponil ® FES 77 | — |
| 42 | 50 (A) | 21 | Disponil ® FES 77 | CaSO₄* 2 H₂0⁸ |
| 43 | 50 (A) | 21 | Disponil ® FES 77 | CaSO₄* 2 H₂0⁹ |
| 44 | 50 (A) | 21 | Disponil ® FES 77 | CaSO₄ * 0.5 H₂0¹⁰ |
| 45 | 50 (A) | 21 | Disponil ® FES 77 | CaSO4¹¹ |
| 46 | 50 (C)¹² | 3 | Disponil ® FES 77 | — |
| 47 | 50 (C) | 3 | Disponil ® FES 77 | — |
| 48 | 50 (C) | 3 | Disponil ® FES 77 | Ca(OH)₂¹³ |
| 49 | 50 (C) | 3 | Disponil ® FES 77 | Ca(OH)₂¹⁴ |
| 50 | 50 (C) | 3 | — | — |
| 51 | 50 (B) | 21 | Disponil ® FES 77 | Lignin¹⁵ |
| 52 | 50 (B) | 21 | Disponil ® FES 77 | Na₃P₃O₉¹⁶ |
| 53 | 50 (B) | 21 | Disponil ® FES 77 | Apyral 60 D¹⁷ |
| 54 | 50 (B) | 21 | Disponil ® FES 77 | Blanc Fixe N¹⁸ |
| 55 | 50 (B) | 21 | Disponil ® FES 77 | Waterglass¹⁹ |

⁶Amount of dispersion = 100% − amount of acrylate resin solution
⁷32% strength by weight; amount used 2.5% by weight, based on the dispersion
⁸10% by weight based on polymer fraction of the binder
⁹20% by weight based on polymer fraction of the binder
¹⁰10% by weight based on polymer fraction of the binder
¹¹10% by weight based on polymer fraction of the binder
¹²without TEtA
¹³4% by weight based on polymer fraction of the binder
¹⁴8% by weight based on polymer fraction of the binder
¹⁵20% by weight based on polymer fraction of the binder
¹⁶10% by weight based on polymer fraction of the binder
¹⁷20% by weight based on polymer fraction of the binder
¹⁸20% by weight based on polymer fraction of the binder
¹⁹10% by weight based on polymer fraction of the binder

Comparative examples (N-methylol-containing binders)

| Comparative | | | Mixing ratio |
|---|---|---|---|
| example | Dispersion | Resin | Dispersion/resin |
| 1 | Acronal ® S 747 | | 100 |
| 2 | Acronal ® S 747 | Saduren ® 163 | 90/10 |

Results of performance characteristics

| | Max. tensile | Elongation | |
|---|---|---|---|
| | force/elongation at break | at 200° C. and | Hydrophilicity |
| Example | [N m²/(g 5 cm)]/[%] | 80 N [%] | [mm] |
| 1 | 2.9/27 | 8.6 | 5 |
| 2 | 3.1/29 | 7.7 | 2 |
| 3 | 3.3/32 | 8.3 | 0 |
| 4 | 2.6/21 | 6.7 | 0 |
| 5 | 3.3/28 | 8.0 | 2 |
| 6 | 3.1/24 | 8.6 | 2 |
| 7 | 3.1/26 | 7.6 | 0 |
| 8 | 2.9/26 | 7.4 | 1 |
| 9 | 3.1/28 | 7.2 | 1 |
| 10 | 3.1/30 | 8.5 | 37 |
| 11 | 3.0/31 | 6.0 | 33 |
| 12 | 3.0/32 | 8.0 | 37 |
| 13 | 3.2/35 | 15.4 | 0 |
| 14 | 3.2/36 | 12.8 | 14 |
| | Max. tensile | Elongation | |
| | force/elongation at break | at 200° C. and | Hydrophilicity |
| Example | [N m²/(g 5 cm)]/[%] | 40 N [%] | [mm] |
| 15 | unstable, not measurable | | |
| 16 | 3.5/35 | 3.4 | 2 |
| 17 | 3.5/35 | 3.3 | 2 |
| 18 | 3.4/35 | 3.4 | 2 |
| 19 | 2.3/28 | 4.2 | 0 |
| 20 | 3.1/80 | 3.7 | 0 |
| 21 | 3.0/39 | 5.3 | 2 |
| 22 | 2.6/32 | 4.7 | 2 |
| 23 | unstable, not measurable | | |
| 24 | unstable, not measurable | | |
| 25 | unstable, not measurable | | |
| 26 | 3.4/35 | 3.4 | 2 |
| 27 | unstable, not measurable | | |
| 28 | unstable, not measurable | | |
| 29 | 3.3/34 | 3.6 | 0 |
| 30 | 3.0/33 | 3.5 | 0 |
| 31 | 3.4/38 | 3.3 | 0 |
| 32 | 3.3/37 | 3.1 | 0 |
| 33 | 3.5/40 | 3.0 | 0 |
| 34 | 3.5/36 | 3.0 | 0 |
| 35 | 3.5/37 | 3.4 | 0 |
| 36 | 3.2/34 | 3.5 | 0 |
| 37 | 3.4/37 | 3.0 | 0 |
| 38 | 3.0/28 | 3.3 | 0 |
| 39 | 3.3/35 | 3.2 | 4 |
| 40 | 3.3/35 | 3.3 | 5 |
| 41 | 3.0/28 | 3.5 | 3 |
| 42 | 3.3/35 | 3.1 | 0 |
| 43 | 3.1/32 | 2.9 | 0 |
| 44 | unstable, not measurable | | |
| 45 | unstable, not measurable | | |
| 46 | | 4.0 | |
| 47 | | 3.5 | |
| 48 | | 3.3 | |
| 49 | | 3.0 | |
| 50 | | 3.3 | |
| 51 | unstable, not measurable | | |
| 52 | 3.4/33 | 3.3 | 0 |
| 53 | unstable, not measurable | | |
| 54 | 3.2/36 | 3.2 | 0 |

| | |
|---|---|
| 55 | unstable, not measurable |

Results for performance characteristics of the comparative examples

| | Max. tensile | Elongation | |
|---|---|---|---|
| | force/elongation at break | at 200° C. und | Hydrophilicity |
| Example | [N m²/(g 5 cm)]/[%] | 40 N [%] | [mm] |
| 1 | 3.5/39 | 5.5 | 56 |
| 2 | 2.8/26 | 3.5 | 38 |

1. The method of using as a binder for substrates a heat-curable aqueous composition comprising dispersed polymer particles of at least
(a) one polymer A1 comprising,
98-100% by weight of ethylenically unsaturated monomers A, it being possible for up to 20% by weight of the monomers A to comprise glycidyl and/or hydroxyl groups and/or amino/amido groups, and the polymer comprising, incorporated in the form of polymerized units, ≦5% by weight of an α,β-ethylenically unsaturated mono- or dicarboxylic acid and at least 1% by weight of acrylonitrile, and 0-5% by weight of a bi- or polyfunctional monomer and
(b) a polymer A2 which is soluble in the serum and comprises, incorporated in the form of polymerized units, 60-100% by weight of at least one α,β-ethylenically unsaturated mono- or dicarboxylic acid whose carboxyl groups can form an anhydride group, salts or mixtures thereof
(c) and a polyfunctional crosslinking agent or mixtures thereof
(d) and, if appropriate, divalent or trivalent metal ions which are added in the form of hydroxides, oxides, carbonates or bicarbonates.

2. The method according to claim 1, wherein the aqueous composition is prepared by free radical emulsion polymerization of the polymer A1 in the presence of polymer A2.

3. The method according to claim 1, wherein the aqueous composition is obtained by mixing the polymers A1 and A2.

4. The method according to claim 1, wherein acrylic acid, methacrylic acid, itaconic acid, maleic acid, fumaric acid, crotonic acid, their anhydrides or mixtures thereof are used as ethylenically unsaturated mono- or dicarboxylic acids.

5. The method according to claim 1, as a binder for fibers, fiber mats and fiber webs.

6. The method according to claim 1, as a binder for glass fibers, glass surfacing mats, glass mats, mineral fibers, mineral webs and mineral mats.

7. The method according to claim 1, as substrate material for bituminized roofing sheets.

8. The method according to claim 1 as a fiber web for cleaning and wiping cloths.

9. The method according to claim 1 as a binder for filter materials.

10. The method according to claim 1 as a binder for wallpaper substrate webs.

11. The method according to claim 1 as a binder for inliner or substrate material for floor coverings.

12. A method for the production of bonded fiber webs, wherein fiber webs are coated, sprayed or impregnated with an aqueous binder according to claim 1 and then dried.

13. The method according to claim 12 for the production of bonded glass surfacing mats or glass mats.

14. A bound fiber web or fiber mat, obtainable by using a formaldehyde-free aqueous binder according to claim 1.

15. A bound glass surfacing mat or glass mat, obtainable by using a formaldehyde-free aqueous binder according to claim 1.

16. A roofing sheet comprising bound fiber webs or fiber mats according to claim 14.

17. A roofing sheet comprising bound glass surfacing mats or glass mats according to claim 15.
